(19) United States
(12) Patent Application Publication
(10) Pub. No.: US 2009/0073476 A1
(43) Pub. Date: Mar. 19, 2009

(54) PRINTING APPRATUS AND SYSTEM

(75) Inventor: Keiko Torikoshi, San Mateo, CA (US)

Correspondence Address: YING CHEN;Chen Yoshimura LLP, 255 S. GRAND AVE., # 215, LOS ANGELES, CA, 90012, US

(73) Assignee: KONICA MINOLTA SYSTEMS LABORATORY, INC., Huntington Beach, CA (US)

(21) Appl. No.: 11/855,126

(22) Filed: Sep. 13, 2007

(51) Int. Cl. G06F 3/12

(52) U.S. Cl. 358/1.13; 358/1.1; 358/1.15; 358/1.16; 358/1.18

(57) ABSTRACT

A printing system includes a print device having a paper tray and a sensor disposed adjacent to the paper tray, the sensor being configured to sense a feature formed on a paper that resides in the paper tray; and a computer connected to the print device, the computer including a printer driver for driving the print device, the printer driver processing data provided from the sensor and generating positional information indicating a position of the feature on the paper, the computer system further including a display monitor to display the position of the feature on the paper so that the position of the feature on the paper can be discerned before printing operation.

### BACKGROUND OF THE INVENTION

1. Field of the Invention

This invention relates to printing apparatus and system.

2. Description of Related Art

In today's modern office environment, it is imperative to have the capability of precisely positioning printed text and graphics on various types of specialty paper. For example, letters to be mailed to customers should be printed on pre-prepared company letterheads, which are typically made of bond paper bearing a company logo inscribed thereon. Accounting information may need to be printed on three punch-holed papers for filing in appropriate binders.

Office environments in large organizations typically have many types of printers connected in various ways; such as stand-alone printers connected to individual printers as well as network printers controlled by a printer server. Each of such printers has one or more paper trays, such as large capacity paper trays, a manual feed tray, and universal trays, to accommodate various types of paper. In order to print characters and graphics at exact desired positions, it is often necessary to perform several trials-and-errors to produce desired results. For example, in a first few trials, the left edge of the text may not be perfectly aligned with the left edge of the company logo inscribed on the company letterhead, providing unsatisfactory appearance; the printed address on an envelope may be upside down with respect to envelope orientation; or punch holes in three punch hole paper may overlap the text and graphics printed by the printer. This is often annoying and inconvenient especially when one is pressed with time-sensitive tasks.

More specifically, FIG. 1 illustrates a typical print preview window in a word processing software in the conventional art. As shown in FIG. 1, while the paper size and the position of the text and graphics relative to the paper edge can be recognized by this view, the position of company logos or other physical objects such as punch holes, scribe lines, etc., cannot be understood. Moreover, the paper in the paper tray in question may be installed upside down or in a reversed manner. Often, these deficiencies can be recognized only after the printing operation is completed and the printed paper is actually reviewed by a user.

In some application software, specialty paper types, such as predetermined label formats or envelope formats can be chosen and the preview window indicate boundaries or features that are supposedly on the paper. However, this assumes that the user inserts an appropriate specialty paper in the right orientation into a right paper tray. Typically, a few trials and errors are still required in order to adjust the position of the printed text on the paper.

### SUMMARY OF THE INVENTION

Accordingly, the present invention is directed to printing apparatus and system that substantially obviate one or more of the problems due to limitations and disadvantages of the related art.

An object of the present invention is to provide an improved printing apparatus and system.

Additional or separate features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, in one aspect, the present invention provides a method of providing a print preview image with a user, the method including the steps of sensing an image of a paper accommodated in a paper tray of a print device by an image sensor disposed adjacent to the paper tray; and displaying on the print preview window a merged image of a first image and a second image, the first image being an image prepared based on a document prepared by an application program, the second image being an image prepared based on the image of the paper in the paper tray sensed by the image sensor.

In another aspect, the present invention provides a printing system including a print device having a paper tray and a sensor disposed adjacent to the paper tray, the sensor being configured to sense a feature formed on a paper that resides in the paper tray; and a computer connected to the print device, the computer including a printer driver for driving the print device, the printer driver processing data provided from the sensor and generating positional information indicating a position of the feature on the paper, the computer system further including a display monitor to display the position of the feature on the paper so that the position of the feature on the paper can be discerned before printing operation.

In another aspect, the present invention provides a printing system that includes a print device having a paper tray and a sensor disposed adjacent to the paper tray, the sensor being configured to sense a feature formed on a paper that resides in the paper tray; and a processor connected to the print device, the processor processing data provided from the sensor to determine a paper size of the paper and a position of the feature on the paper, the processor being configured to store the processed data indicating the paper size and the position of the feature on the paper as a form data so that an application software that can print information on said paper can access the form data in advance of printing operation.

In another aspect, the present invention provides a print device that includes a paper feed tray; and a sensor disposed adjacent to the paper feed tray, the sensor being configured to sense a feature formed on a paper that resides in the paper feed tray.

In another aspect, the present invention provides a method of preparing for printing, implemented in a printing system with a display monitor, the printing system including a paper feed tray and a sensor disposed adjacent to the paper feed tray, the sensor being configured to sense a feature formed on a paper that resides in the paper feed tray, the method including receiving a command from a user to instruct the sensor adjacent to the paper feed tray to detect a feature on the paper in the paper feed tray; and storing information of the feature on the paper detected by the sensor in a storage media as a form data to that an application software that can print information on said paper can access the form data in advance of printing operation.

In another aspect, the method of preparing for printing further includes receiving a print preview command from a user; retrieving the form data from the storage media; processing the retrieved form data together with information to be printed on the paper to merge the form data with the information to be printed on the paper; and causing the display monitor to display a superimposed image of the information to be printed on the paper and the detected feature on the paper so that a user can discern a positional relationship between the information to be printed and the feature on the paper.

It is to be understood that both the foregoing general description and the following detailed description are exemplary and explanatory, and are intended to provide further explanation of the invention as claimed.

### BRIEF DESCRIPTION OF THE DRAWINGS

FIG. 1 schematically illustrates a typical print preview window in word processing software in the conventional art.

FIG. 2 schematically illustrates a print preview window in word processing software according to an embodiment of the present invention.

FIGS. 3 and 3-1 schematically illustrate a structure of a print device according to an embodiment of the present invention.

FIG. 4 schematically illustrates a printing system according to an embodiment of the present invention.

FIG. 5 is a block diagram schematically illustrating various components of a printing system according to an embodiment of the present invention.

FIG. 6 is a flow chart illustrating a process flow according to an embodiment of the present invention.

FIG. 7 shows a process flow for creating form data according to an embodiment of the present invention.

FIG. 8 shows an example of a Print Property window available in an application according to an embodiment of the present invention.

### DETAILED DESCRIPTION OF THE PREFERRED EMBODIMENTS

According to embodiments of the present invention, the positions of company logos, three punch holes, etc., can be gained from actual paper accommodated in a paper tray on which the printing job is actually being performed. Accordingly, users can confirm and assure precise positioning of the texts and graphics that are being printed relative to these features on the paper.

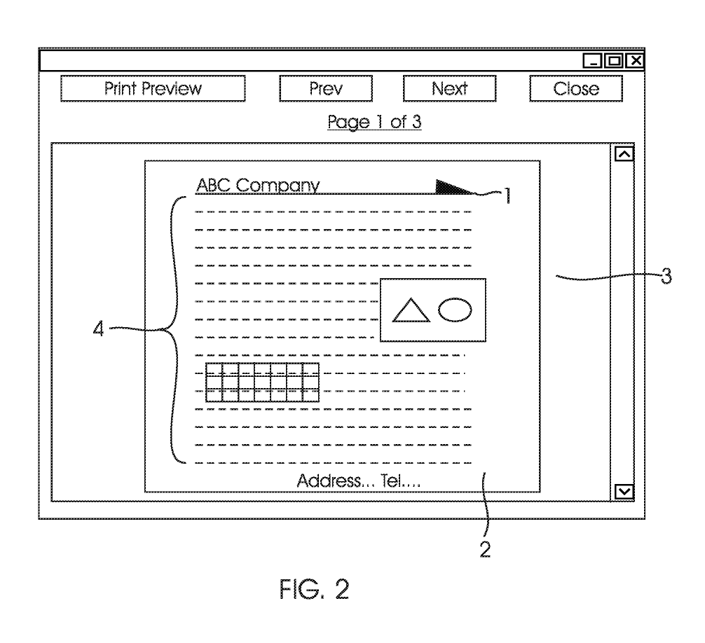

FIG. 2 schematically illustrates a print preview window in word processing software shown in a display monitor according to an embodiment of the present invention. In this exemplary preview window, company logo 1 and footer 2 showing company contact information are shown in the preview window as well as text and graphics 4 that are being printed on the paper 3. The company logo 1 and footer 2 are detected by a sensor installed on the print device and their images are superimposed on the text and graphics that will be printed on the paper by this word processing software. Therefore, the existence and position of features present in the paper as well as paper orientation can be confirmed prior to the execution of printing operation.

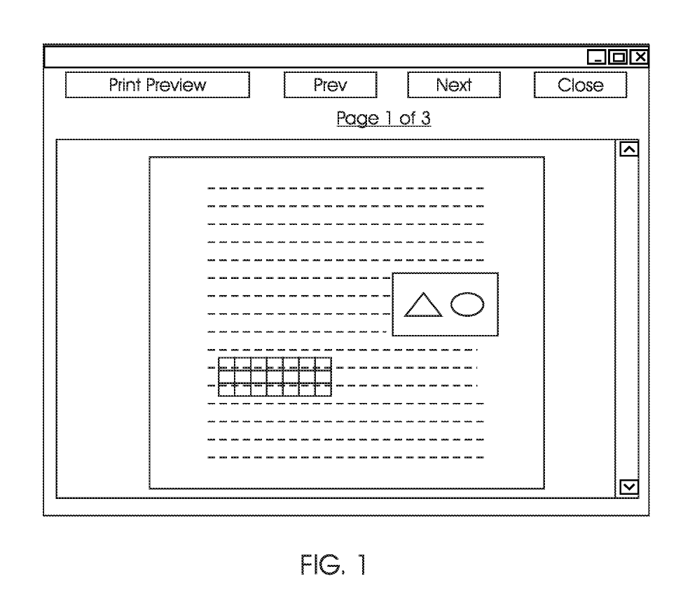

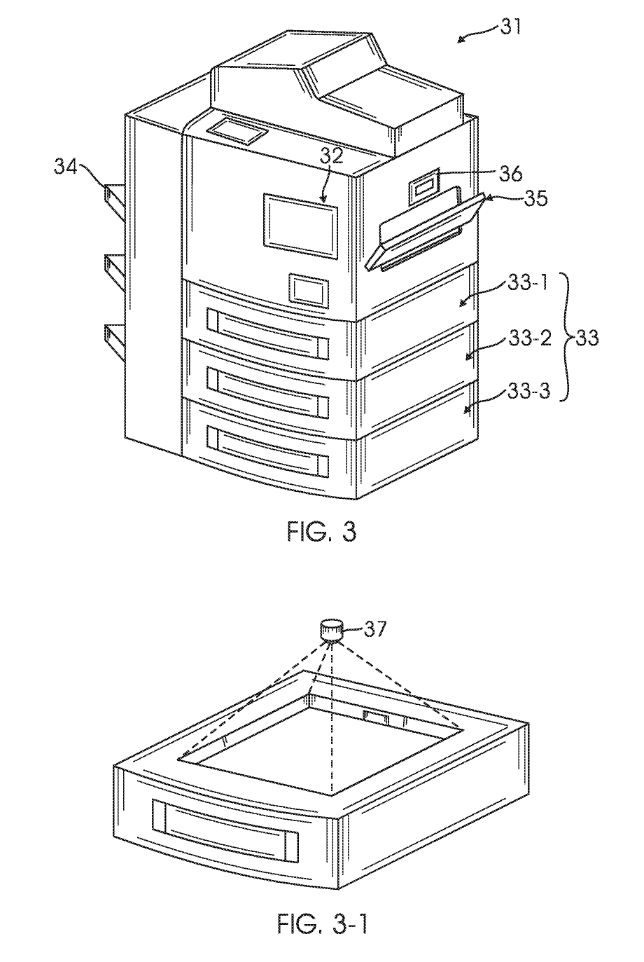

In order to capture images of these features, a print device of the present invention is equipped with a sensor to detect the features on paper which is installed in a paper tray. FIGS. 3 and 3-1 schematically illustrate a structure of a print device according to an embodiment of the present invention. The print device (physical printer) 31 has printing engine 32, one or more of paper trays 33, 35, and paper output trays 34. The paper trays 33 store paper of various sizes and color and can store a large volume of paper so that uninterrupted printing operation is possible. Manual feed tray 35 may also be provided for manual feed of paper. Sensor 36 is installed to capture an image of paper placed on the manual feed tray 35. Furthermore, sensor 37 is provided to capture an image of paper in paper tray 33. For example, sensor 37 for the top tray 33-1 is installed on the print device body at an appropriate location. Sensor 37 for the second tray 33-2 is installed on the bottom of the paper tray 33-1, and sensor 37 for the third tray 33-3 is installed on the bottom of the papery tray 33-2. Trays 33-1, 33-2, 33-3 may be universal trays, fixed paper trays or may be of any other types. Sensors 36 and 37 can be CCD (Charge Coupled Device) image sensors. CMOS (Complementary Metal Oxide Semiconductor) image sensor can be used as the sensors 36 and 37 in lieu of CCD image sensors. In one embodiment, infrared imaging devices can be used as these sensors so that the images of the papers accommodated in the trays 33-1, 33-2, and 33-3 can be sensed even when visible light cannot reach the inside of the trays. Further, visible light sources or other light sources may be provided to illuminate the inside of the trays so that the image sensors or infrared imaging devices can sense paper in the trays more effectively.

Sensors 36, 37 can be a CCD image sensor that captures an image in its respective field of view. Depending on the physical properties and arrangements of the sensor and optical system relative to the paper to be detected, it may have a wide-angle field of view. Print device 31 is provided with appropriate hardware and software to process data from sensors 36 and 37. The sensors can detect the paper size, such as 8.5×5.5, letter, invoice size, legal, or ledger size. If the paper size is custom size, the system can be configured such that it will be rounded to the nearest predefined one. The sensor also detects special features on the paper, such as punch holes, logo, or header/footer. These features are extracted as a feature and stored as a form together with paper size information. The area adjacent to the feature is considered as non-printable area. Non printable area is defined as an area including the detected features together with the 0.5 mm margins from each of the features, for example. This definition can be altered by way of user specifying optional parameters or the like.

When “Preview” is selected from the print setting window, the form is retrieved and is merged with the application data. (In the case of Mac OS, the internal data format handled here is PDF, and in the case of Windows Vista, the format is XPS.) Therefore users can ensure that their text or graphics do not overlap undesired features on the paper.

Sensors discussed here may be a line sensor together with a moving mechanism to scan the image of the paper.

Appropriate software and hardware can be provided such that even if the image captured by a CCD has an insufficient resolution, it is possible to determine the closest paper format among the pre-stored types of papers. For example, if there are three versions of company letterheads and two versions of company envelopes as well as standard letter-size paper, the coarse image captured by the low resolution image sensor is sufficient for an appropriate software program to discern which one of these types of paper is in the tray, and whether the paper orientation is appropriate.

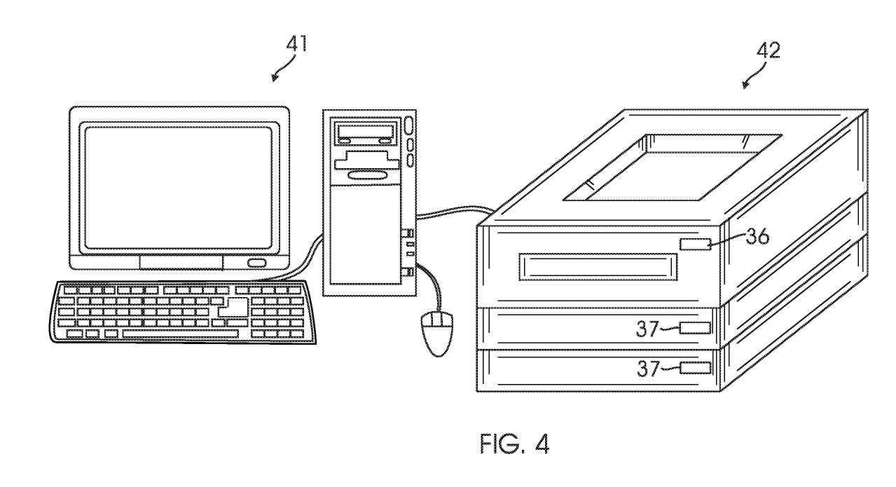

FIG. 4 schematically illustrates a printing system according to an embodiment of the present invention. A computer 41 with an appropriate I/O device is connected to a display monitor and communicates with a print device 42, which is equipped with one or more of the sensors 36, 37 described above with reference to FIGS. 3 and 3-1. An appropriate operating system, such as Windows OS, Unix OS, or Mac OX, as well as various applications, such as word processing applications, drawing applications, CAD applications, are installed in computer 41, for example. A printer driver suitable for driving the print device 42 is also installed on the computer 41 so that the operating system and applications can communicate with the printer 42.

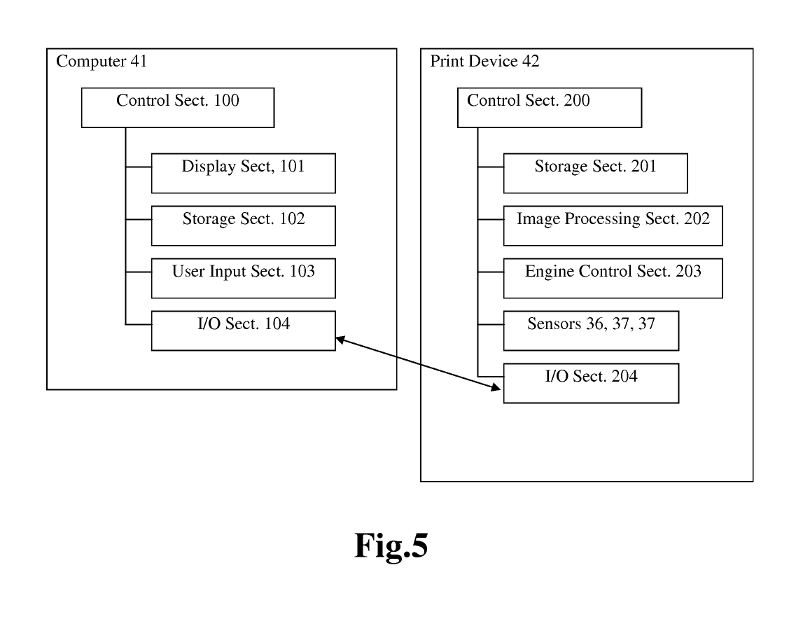

FIG. 5 is a block diagram schematically illustrating various components of a printing system according to an embodiment of the present invention. As shown in FIG. 5, the computer 41 includes a control section 100, a display section 101, a storage section 102, a user input section 103, an input/output section 104. The control section 100 includes a CPU, a RAM, and a ROM, for example. The storage section 102 is, for instance, an HDD in which software including the Operation System, the printer driver, the application programs are stored. The control section 101 reads out software from the storage section and carries out various processes in accordance with the software. The user input section 103 includes a keyboard and a mouse from which the user can prepare a document to be printed through the application program, and set up print conditions through the printer driver. Input/output section 104 can be any kind of communication interface suitable for communicating with the print device 42, such as for instance, USB, Ethernet® or serial interface.

On the other hand, the print device 42 includes a control section 200, a storage section 201, an image processing section 202, an engine control section 203, sensors 36, 37, 37, and an input/output section 204. The control section 200 includes a CPU, a RAM, and a ROM, for example. The storage section 201 is, for instance, an HDD in which software including an application program so called an interpreter, and an application program for processing image data from sensors 36, 37, 37 are stored. Similar to the computer 41, the control section 200 reads out software from the storage section 202 and carries out various processes in accordance with the software. Specifically, the control section 200 functions as the interpreter, so that print data in a form of page description language is parsed and bitmap image data is then generated. In the mean time, the control section 200 also controls the above-described sensors in accordance with an appropriate software program. The image processing section 202 is hardware in which, under the control of the control section 200, a variety of image processings including a color conversion and a dither processing are carried on the bitmap image data generated by the interpreter. Engine control section 203 controls print engine under the control of the control section 200 so that an image is printed on a paper in accordance with the bitmap image data processed by the image processing section 203. The input/output section 204 has a structure similar to that of the input/output section 104 of the computer 41.

In this exemplary configuration explained above, the printer driver in the computer 41 is equipped with additional functionalities to receive and process data from the sensor 36, 37, 37 in the print device 42 so that the position and shape of physical features on paper, such as company logo, punch holes, etc., can be discerned with respect to paper provided at the top of the tray.

For example, when a company letterhead is installed on one of the trays in the print device 42, the corresponding one of the sensors 36, 37, 37 captures an image of the letterhead. The bitmap image data representing the image captured by the sensor in the print device 42 can be directly forwarded to the printer driver (or other appropriate software) on the computer 41. The printer driver then processes the data and converts the bitmap image data into information indicating the shape and location of the company logo with respect to the paper boundary. The processed information is stored as a form data in the storage section 102 of the computer 41 (or in the storage section 201 in the print device 42). Any applications installed on the computer 41 can utilize this form data by accessing the printer driver, and can display the company logo on the print preview window in a manner similar to that depicted in FIG. 2. For example, when a print preview function is called in the word processing application, the application calls for the printer driver and requests the form data indicating the shape and position of the company logo (or any other features on the paper) as well as information regarding paper size, printing resolution, etc. Then, the word processing application causes a display monitor attached to the computer to display the company logo on a screen display of the paper and superimposes the image of the text and graphics that are going to be printed on the paper onto the paper image thus created. This way, the user can confirm that the paper is provided in the right orientation, and how the text and graphics she/he is creating will be positioned with respect to the logo imprinted on the letterhead.

The form data is stored in the storage section 201 in the print device 42 or the storage section 2102 in the computer 41, for example. Further, other types of storage media such as Flash memories, or a memory such as RAM can be used in lure of the hard drive. The system is configured such that the form data can be merged with the application data when the Preview command is executed. As described above, the form data can be created solely based on the image data captured by the sensor, or a variety of pre-defined form data may be stored and the image captured by the sensor can be compared to the form data to determine the closest by appropriate image processing.

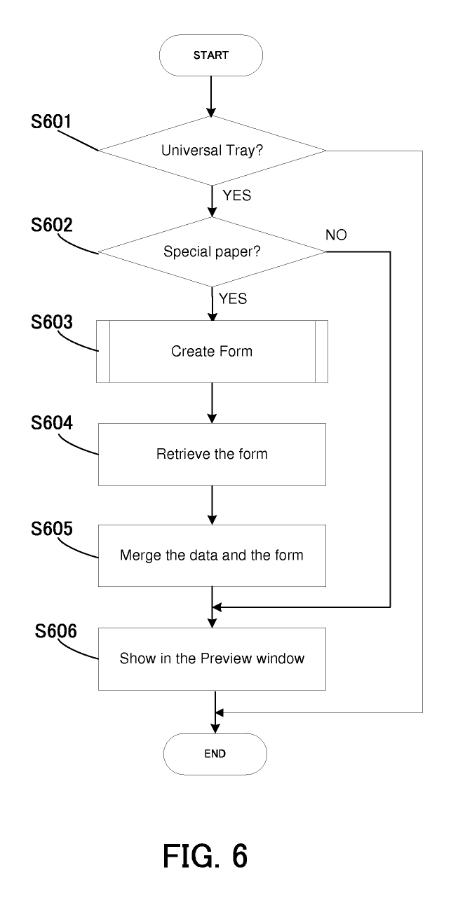

Embodiments of the present invention will be described in more detail with reference to FIGS. 6-8.

FIG. 6 is a flow chart illustrating a process flow in the case of utilizing an image sensor for capturing an image of paper on a universal paper tray. First, the system determines or a user specifies that a printing operation will be conducted on paper stored in the universal papery tray (S601). In a case where the printing is to be executed on the paper in the universal paper tray (S601: Yes), The system next determines whether special paper, such as paper with a company logo is present in the universal tray (S602). If so (S602: Yes), a form data is created (S603). When the user executes the Print Preview command from the application the user is working on, in accordance with the application the control section 100 of the computer 41 retrieves the form data created in step S603 (S604) and merges the data to be printed on the paper with the form data (S605). Then the control section 100 controls the display section 101 so that the merged image is displayed on the Print Preview window (S606).

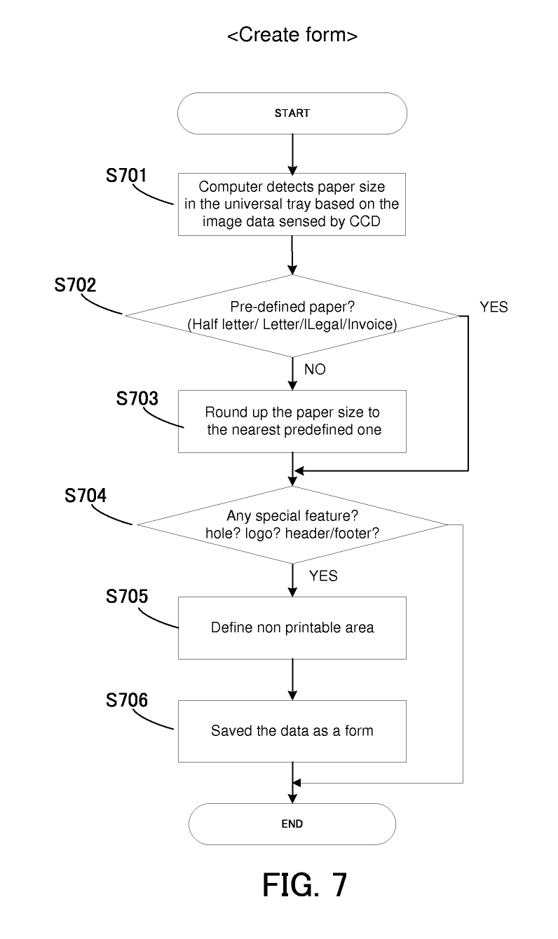

FIG. 7 shows an exemplary process flow focusing on the form data creation (corresponding to step S603 in FIG. 6) according to an embodiment of the present invention. In this example, image data captured by the CCD image sensor is sent to the computer 41, and the control section 100 of the computer 41 detects the paper size of paper stored in the universal tray in accordance with the received image data (S701). The control section 100 then determines whether the paper has one of the predefined paper sizes, such as half size letter, letter size, legal size, invoice size, for example (S702). If so (S072: Yes), then the process flow skips step S703 to go to step S704. If the detected paper size does not belong to any one of the predefined paper sizes (S702: No), then the control section 100 determines the nearest predefined size (S703). Then based on the image data sensed by the CCD image sensor, the control section 100 determines whether any special feature is present on the paper (S704). If so (S074: Yes), a non-printable area(s) is defined by identifying the areas that include the special features with certain margins, for example (S705). In other words, since no image should be printed within any one the special features such as holes, logo, and/or header/footer, each area corresponding to any one of the special features is treated as the non-printable area. Then the information concerning the detected paper size and the defined non-printable area(s) is stored as a form (form data).

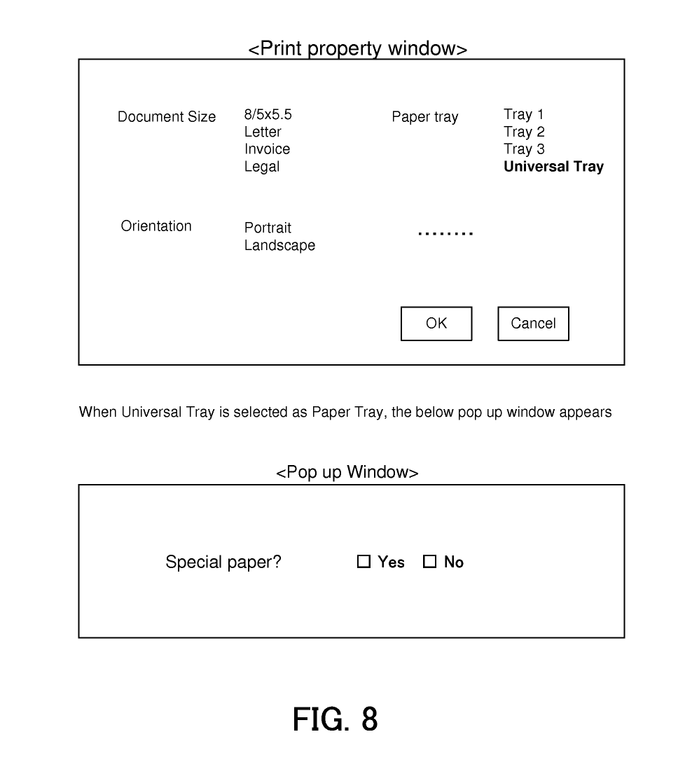

FIG. 8 shows an example of a Print Property window available in a printer driver through an application according to an embodiment of the present invention. As shown in the top figure, when the user selects the Print Property command, various user selectable options are displayed. This includes document size, paper tray identification, and paper orientation, for example. When the user selects the Universal Tray option, another pup-up window appears, as shown in the bottom figure, requesting the user to tell the application whether special paper is present in the universal tray. Thus in this example, the user specifies the tray (corresponding to step S601) and whether paper in it is special paper or not (corresponding to step S602). If the user indicates that there is special paper, then the sensor is activated and steps S603 through step S606 or similar steps are performed.

Various modifications to the data processing scheme are possible. For example, the print device can be provided with an image processor to process bitmap image data captured by the sensor and format it such that the shape and position of the feature on the paper are determined within the print device. The resulting data is stored in a hard drive or other appropriate storage media in the print device as form data. This form data can be then forwarded to the computer to pass onto the application that is calling for this data. In certain circumstances and industrial applications, this configuration may be desirable because information on the shape and position of the feature on the paper are available locally at the print device.

Furthermore, instead of having a printer driver process the image data of the sensor, a separate component, such as an additional driver similar to a scanner driver, can be assigned to process the data from the sensor. In this case, computer operating system and software applications designed to utilize the data from the sensor need to call this additional driver to accomplish the above-described features. As another example, utility software of the printer driver can be installed as a separate component. In this case, the utility software is called by the printer driver or other application so that this software retrieves and processes the bitmap image data of the sensor (or the form data).

Mac OS X uses PDF and Windows Vista uses XPS, respectively, as the internal data format for all data regardless of applications that generate it. Therefore, in these operating systems, even if the application the user is using to create the document differs from the application that creates the above-mentioned form, the merger of the data is possible without additional software. In case that the data format for the form data and the data format for the document are different, additional software may be necessary to appropriately merge these two types of data so that the print preview can show a merged image.

Instead of optical sensors, sensors provided in the print device may be magnetic sensor capable of magnetically detecting magnetic features. For example, a company letterhead may use a magnetic ink for the company logo, and the print device may be provided with a magnetic sensor that can detect the position and the shape of the logo magnetically. This configuration is useful particularly when the printing surface of paper (the surface of paper that will undergo printing) is on a reverse side—i.e., the top surface of paper appeared on the top of the paper feed tray is not the printing side.

It will be apparent to those skilled in the art that various modification and variations can be made in the print management method and apparatus of the present invention without departing from the spirit or scope of the invention. Thus, it is intended that the present invention cover modifications and variations that come within the scope of the appended claims and their equivalents.

What is claimed is:

1. A method of providing a print preview image with a user, the method comprising the steps of:
sensing an image of a paper accommodated in a paper tray of a print device by an image sensor disposed adjacent to the paper tray; and
displaying on the print preview window a merged image of a first image and a second image, the first image being an image prepared based on a document prepared by an application program, the second image being an image prepared based on the image of the paper in the paper tray sensed by the image sensor.

2. The method according to claim 1, further comprising the steps of:
determining if the paper in the paper tray is a special paper; and
preparing form data of the paper based on the sensed image if the paper is determined as the special paper, the form data reflecting at least one feature of the paper that is formed on the paper,
wherein in the displaying step, the second image is prepared based on the form data.

3. A printing system, comprising:
a print device having a paper tray and a sensor disposed adjacent to the paper tray, the sensor being configured to sense a feature formed on a paper that resides in the paper tray; and
a computer connected to the print device, the computer including a printer driver for driving the print device, the printer driver processing data provided from the sensor and generating positional information indicating a position of the feature on the paper, the computer further including a display monitor to display the position of the feature on the paper so that the position of the feature on the paper can be discerned before printing operation.

4. The printing system according to claim 3, wherein the sensor is a CCD sensor and the paper tray is a universal tray.

5. The printing system according to claim 3, wherein the sensor is an infrared sensor.

6. The printing system according to claim 3, wherein the sensor is a magnetic sensor.

7. A printing system comprising:
a print device having a paper tray and a sensor disposed adjacent to the paper tray, the sensor being configured to sense a feature formed on a paper that resides in the paper tray; and
a processor connected to the print device, the processor processing data provided from the sensor to determine a paper size of the paper and a position of the feature on the paper, the processor being configured to store the processed data indicating the paper size and the position of the feature on the paper as a form data so that an application software that can print information on said paper can access the form data in advance of printing operation.

8. The printing system according to claim 7, wherein the processor further defines a non-printable area based on the location of the feature on the paper and includes the defined non-printable area in the stored form data.

9. The printing system according to claim 7, wherein the processor is configured to store the form data in a storage media in the print device.

10. The printing system according to claim 7, wherein the processor is configured to store the form data in a storage media in a computer in which the processor is included.

11. The printing system according to claim 7, further comprising hardware on which application software runs,
wherein the application software running on the hardware is configured to receive a print preview command from a user, and upon receipt of the print preview command, accesses the form data and merges information generated by the application software to be printed on the paper with the form data so that the application software can pass on the merged data to a display monitor to display the information to be printed on the paper together with an image of the paper before printing operation.

12. The printing system according to claim 7, wherein the processor compares the data provided from the sensor with a plurality of pre-stored paper images to determine which one of the pre-stored paper images is closest to a paper image represented by the data provided from the sensor, and the processor identifies the closest one of the pre-stored paper image as the form data.

13. A print device, comprising:
a paper feed tray; and
a sensor disposed adjacent to the paper feed tray, the sensor being configured to sense a feature formed on a paper that resides in the paper feed tray.

14. A method of preparing for printing, implemented in a printing system with a display monitor, the printing system comprising a paper feed tray and a sensor disposed adjacent to the paper feed tray, the sensor being configured to sense a feature formed on a paper that resides in the paper feed tray, the method comprising:
receiving a command from a user to instruct the sensor adjacent to the paper feed tray to detect a feature on the paper in the paper feed tray; and
storing information of the feature on the paper detected by the sensor in a storage media as a form data to that an application software that can print information on said paper can access the form data in advance of printing operation.

15. The method according to claim 14, further comprising:
receiving a print preview command from a user;
retrieving the form data from the storage media;
processing the retrieved form data together with information to be printed on the paper to merge the form data with the information to be printed on the paper; and
causing the display monitor to display a superimposed image of the information to be printed on the paper and the detected feature on the paper so that a user can discern a positional relationship between the information to be printed and the feature on the paper.

16. The method according to claim 14, further comprising the step of receiving a command from a user indicating that a universal tray is selected as the paper feed tray.
